(19) United States
(12) Patent Application Publication
(10) Pub. No.: US 2025/0302691 A1
(43) Pub. Date: Oct. 2, 2025

(54) Scalp Oil Massager

(71) Applicant: T. Jane Harper, Fishers, IN (US)

(72) Inventor: T. Jane Harper, Fishers, IN (US)

(73) Assignee: T. Jane Harper, Fishers, IN (US)

(21) Appl. No.: 18/623,016

(22) Filed: Mar. 31, 2024

(51) Int. Cl. A61H 15/00

(52) U.S. Cl. CPC A61H 15/0092; A61H 2201/0153; A61H 2205/021

(57) ABSTRACT

The Scalp Oil Massager is related to improvements in tools leveraged to oil and massage the scalp and hair. There are known massagers; however, the conventional massagers are not purposed for head and scalp oiling based on user preference. The purpose is to present a Scalp Oil Massager that allows users to oil and massage their hair and scalp simultaneously using the oils of their choosing, with the motion and intensity they prefer without having to place the oil directly in their hands.

### TECHNICAL FIELD

The Scalp Oil Massager, is an invention that relates to hair and scalp maintenance. It is a device that can store the oils of the user's choice in the central oil storage tube handle that stores and disperses the oils to the hair and scalp via the roller balls at the end of the individual disbursement tubes through simple user movement.

### BACKGROUND ART

Massagers are known. However, conventional massagers do not dispense oils. These massagers do not dispense oils based on the individual user's choice. The current massagers do not allow the users ability to select and release oil into their hair and scalp while massaging the scalp.

### DISCLOSURE OF INVENTION

This Scalp Oil Massager, because of its unique customization, enables the users to leverage a variety of various oils based on their preference. The massager does not simply massage the scalp but also releases oils on the hair and scalp.

### SUMMARY OF INVENTION

The purpose is to present a user customizable Scalp Oil Massager that comes in various sizes which range from 20 ml to 40 ml of oil capacity. The top of the tub pops open so that the user can fill the tube with up to 20 ml of oil. The oils dispense to the individual tubes via the connection to the oval platter between the tube and the individual disbursement tubes. The oil is released from the disbursement tubes onto the hair and scalp by movement of the rollerballs which are attached to the individual disbursement tubes via a plastic housing for the rollerballs. The movement of the rollerballs happens via the user's movement of the Scalp Oil Massager tool. The tool is easy to clean as soap and water can be added to the central oil storage tube handle and disbursed through the rollerballs secured by plastic rollerball housing at the end of the individual disbursement tubes.

### DETAILED DESCRIPTION OF PREFERRED EMBODIMENTS

The Scalp Oil Massager has a central oil storage tube handle, an oil cylinder between the central oil storage tube handle and individual disbursement tubes. Each individual disbursement tool has a roller ball at the end. The Scalp Oil Massager has a central oil storage tube handle, an oil cylinder between the central oil storage tube handle and individual disbursement tubes. Each individual disbursement tool has a roller ball at the end.

The size of the Scalp Oil Massager varies in sizes based on model. The models range from a central oil storage tube handle that can hold between 10 ml and 30 ml of oil and between 7 to 12 individual disbursement tubes. The central oil storage tube handle opens at the top so that oil can be added and is made of plastic and is 3 inches long with a 3-inch circumference and a 0.95-inch diameter. The central oil storage tube handle connects to the oil cylinder which is 0.5 inches long, has a 5-inch circumference and a 1.59 inch diameter. They individual disbursement tubes are 5 inches long, have a 0.5-inch circumference and a. 16 inch diameter. The rollerballs at the end of the individual disbursement tubes have a 0.4-inch circumference. These measurements can change depending on the model selected by the user, as models can vary in size. The Scalp Oil Massager is not able to be disassembled. The Scalp Oil Massager is made of various plastic materials. The rollerballs are made of metal.

### BRIEF DESCRIPTION OF PICTURES AND DRAWINGS

FIG. 1—Scalp Oil Massager

The graphical representation of the Scalp Oil Massager. The representation features the handle, the cylinder, the individual disbursement tubes and the rollerballs.

FIG. 2—Central Oil Storage Tube Handle

The handle has a lid that opens allowing the user to add the oil of their choice. The handle can come in different sizes based on the model. The handle is connected to the oil cylinder and is not able to be removed from the cylinder.

FIG. 3—Oil Cylinder

The oil cylinder is connected to the handle and the individual oil disbursement tubes. The cylinder is made of plastic and is melded together with the handle and disbursement tubes.

FIG. 4—Individual oil disbursement tubes with rollerballs

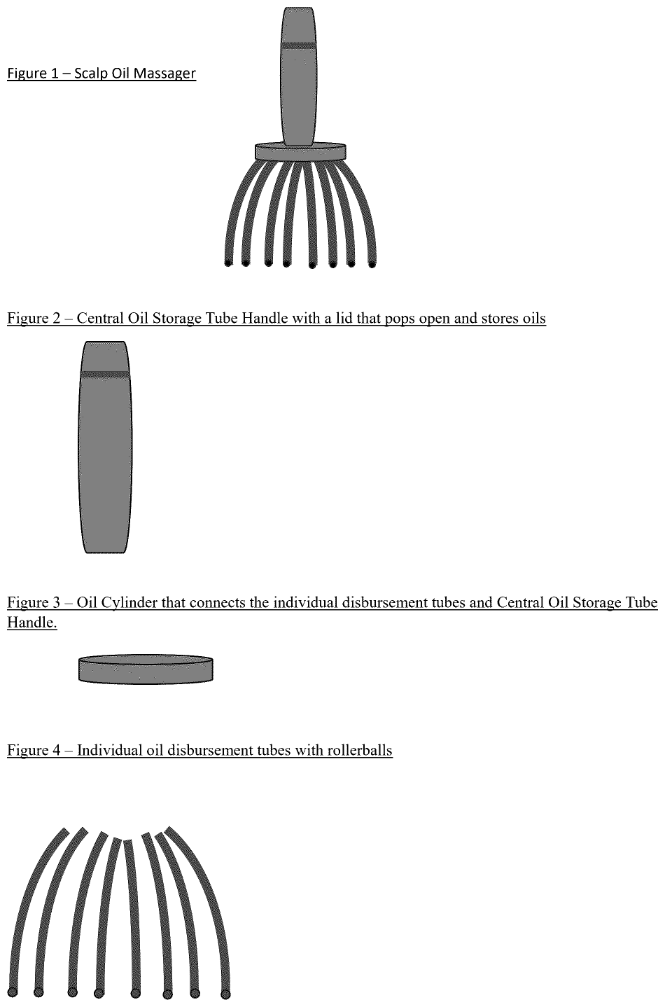

Individual oil disbursement tubes are secured to the rollerballs with a plastic holding. The Individual oil disbursement tubes are connected to the oil cylinder via individual holes that are molded to the oil cylinder. The oil cylinder and the individual disbursement tools are made of plastic.

1. Scalp Oil Massager.
